(19) United States
(12) Patent Application Publication
(10) Pub. No.: US 2017/0008403 A1
(43) Pub. Date: Jan. 12, 2017

(54) SELF-EXICITED AND CONTROLLABLE HYBRID ELECTROMAGNETIC BRAKING (HEB) SYSTEM

(71) Applicants: Reza Yazdanpanah, Lar (IR); Mojtaba Agha-Mirsalim, Lar (IR); Amirkabir University of Technology, Tehran (IR); Iranian National Science Foundation, Tehran (IR)

(72) Inventors: Reza Yazdanpanah, Lar (IR); Mojtaba Agha-Mirsalim, Lar (IR)

(21) Appl. No.: 14/722,099

(22) Filed: May 26, 2015

(51) Int. Cl. B60L 7/26; B60L 7/28

(52) U.S. Cl. CPC B60L 7/26; B60L 7/28

(57) ABSTRACT

The embodiments herein provide a self-excited contact less Hybrid Electromagnetic Braking (HEB) system provided with a both Permanent Magnetic (PM) type ECB and electrically excited windings type ECB. The HEB system has an Eddy Current Brake (ECB) and a Regenerative Brake (RB) with two outer rotors and a common internal stator. The rotor assembly of the RB is coupled to the same shaft on which the ECB rotor is mounted. The RB collects an input mechanical power from the shaft to supply electrical power to ECB windings through a power electronic interface module. A controller measures the system conditions to send a control signal to the power electronic interface module to control a power flow from RB to ECB. The ECB and RB develops two braking torques on the shaft to initiate a braking action in the vehicle.

### SPONSORSHIP STATEMENT

This application is financially sponsored for international filing by the IRANIAN NATIONAL SCIENCE FOUNDATION (INSF).

### BACKGROUND

Technical Field

The embodiments herein are generally related to vehicle braking systems. The embodiments herein are particularly related to Eddy Current Braking (ECB) system in vehicles. The embodiments herein are more particularly related a Hybrid Electromagnetic Braking (HEB) system for achieving a controllability of the braking system without need of an external source.

Description of the Related Art

An Eddy Current Brake (ECB), like a conventional friction brake, is a device used to slow or stop a moving object by dissipating kinetic energy as heat. The ECBs are operated by inducing Eddy Currents (EC) in conductive parts while the parts move in a magnetic field. The ECBs offers an alternative to conventional friction-based brakes and have the advantage of contactless operation.

In the existing ECB systems, flux source is produced either by using Permanent Magnets (PMs) or by electrically exciting the ECB windings. Even though the usage of PMs eliminates the need for an external power supply, the system suffers some major drawbacks. The induced eddy currents produce high temperatures and reaction fields inside the system thereby causing controllability issues and further demagnetizing the PMs. As a result, a performance and a lifetime of the vehicle is affected. On the other hand, a good controllability is achieved over the system by electrically exciting the ECB windings. But the system needs an external power source to excite the windings. Further, the system becomes ineffective when the external power supply fails.

Some existing systems use conventional mechanical friction based brakes. This type of braking system cause problems like wear and tear, environmental pollution, fading, and create dynamic stability controls. Further, the design of these brakes are complex and hard to integrate with vehicle anti-lock system. In some other systems, magnetic regenerative brakes are used. These systems have a weak braking performance due to an absence of complementary braking torque component. Also, these systems fail to restore energy when the rate of energy restoration in vehicle is high. The mechanically controlled brake systems require an additional energy and complex and expensive controls.

Hence, there is need for a Hybrid Electromagnetic Braking (HEB) system that takes an advantage of both Permanent Magnetic (PM) type ECB and electrically excited windings type ECB to achieve a controllability of the braking system without needing an external source. There is also a need for an integrated and compact braking structure that enhances a mechanical strength and reduces production cost and volume of the brake system. There is also a need for a HEB system that overcomes the problems of conventional magnetic, mechanical and hybrid brake systems. Further, there is also a need for a HEB system that contributes more effectively to the braking action of the vehicle.

The above mentioned shortcomings, disadvantages and problems are addressed herein and which will be understood by reading and studying the following specification.

### OBJECT OF THE EMBODIMENTS

The primary object of the embodiments herein is to provide a Hybrid Electromagnetic Braking (HEB) system that comprises both Permanent Magnetic (PM) type ECB and electrically excited windings type ECB to take advantage of both types of ECB to achieve a controllability of the braking system without requiring an external source.

Another object of the embodiments herein is to provide an integrated and compact braking structure to enhance a mechanical strength and reduce a production cost and volume of the brake system.

Yet another object of the embodiments herein is to provide a HEB system that contributes more effective braking action of a vehicle when compared to that of a single ECB and Regenerative Brakes (RB).

Yet another object of the embodiments herein is to provide a self-excited, contact less HEB system with electrically controllable braking performance.

Yet another object of the embodiments herein is to provide a HEB system with a control algorithm that is capable of efficiently tracking a performance of brake system in a vehicle while ensuring a stability of the closed-loop system.

Yet another object of the embodiments herein is to provide a HEB system that minimizes volume and material usage of the brake system and easily implemented in wheels of electric and hybrid vehicles.

Yet another object of the embodiments herein is to provide a HEB system with a control scheme that does not require exact information about the brake and vehicle parameters for the designing the controller.

Yet another object of the embodiments herein is to provide a HEB system that overcomes the problems of conventional magnetic, mechanical and hybrid brake systems such as wear and tear, environmental pollution, fading, slow control dynamics, complexity in integration with anti-lock, dynamic stability controls, weak braking performance due to the absence of the complementary braking torque component, high rate of energy restoration, complex and expensive controls, and requirement of additional energy and components.

These and other objects and advantages of the embodiments herein will become readily apparent from the following detailed description taken in conjunction with the accompanying drawings.

### SUMMARY

The following details present a simplified summary of the embodiments herein to provide a basic understanding of some aspects of the embodiments herein. This summary is not an extensive overview of the embodiments herein. It is not intended to identify key/critical elements of the embodiments herein or to delineate the scope of the embodiments herein. Its sole purpose is to present some concept of the embodiments herein in a simplified form as a prelude to the more detailed description that is presented later.

The other objects and advantages of the embodiments herein will become readily apparent from the following description taken in conjunction with the accompanying drawings.

According to an embodiment herein, a Hybrid Electromagnetic Braking (HEB) system is provided. The system comprises an Eddy Current Brake (ECB) with an outer rotor assembly placed on a shaft of a vehicle. A Regenerative Brake (RB) with an outer rotor assembly is mounted on the shaft of the vehicle to supply input power to the ECB. A power electronics interface module is arranged between the ECB and the RB to supply the input power received from RB to the ECB. A controller is connected to the power electronics interface module to send a control signal to the power electronics interface module to control a power flow from the RB to the ECB to achieve a desired braking torque.

According to an embodiment herein, the controller receives a current vehicle system conditions and compares the received vehicle system conditions with a stored reference conditions to generate the control signal to control a power flow from the RB to the ECB to achieve the desired braking torque of the vehicle.

According to an embodiment herein, the outer rotor assembly of the RB and the outer rotor assembly of the ECB are mounted on a same shaft.

According to an embodiment herein, the power electronic interface module rectifies AC output power of the RB to a controllable DC power.

According to an embodiment herein, the ECB is configured to produce a first braking torque on the shaft, and wherein the RB is configured to produce a second braking torque on the shaft.

According to an embodiment herein, the outer rotor assembly of the RB and the outer rotor assembly of the ECB are connected to a common internal stator.

According to an embodiment herein, the system further comprises a plurality of sensors for measuring the vehicle conditions.

According to an embodiment herein, the measured vehicle conditions are mass, speed and slip of a vehicle.

According to an embodiment herein, the controller is further configured to track a braking torque and wheel slip of the vehicle in a closed loop system.

According to an embodiment herein, the RB is configured to direct generated power into a storage device of the vehicle.

According to an embodiment herein, a method is provided for initiating a braking action in a vehicle using a self-excited and controllable Hybrid Electromagnetic Braking (HEB) system. The method comprising steps of receiving a break command from a driver of the vehicle; measuring system conditions of the vehicle using a plurality of sensors; calculating a braking torque required to stop the vehicle using a controller; comparing the measured vehicle conditions with a reference vehicle conditions by the controller to generate a control signal for achieving a desired braking torque of the vehicle; forwarding the generated control signal to a power electronic interface module to regulate an input power supply to an Eddy Current Brake (ECB) from a Regenerative Brake (RB) for achieving a desired braking torque of the vehicle; and applying a first braking torque produced by the ECB and a second braking torque produced by the RB on a shaft of the vehicle thereby initiating a braking action to stop the moving vehicle.

According to an embodiment herein, the measured vehicle conditions are mass, speed and slip of a vehicle.

According to an embodiment herein, the method further comprises tracking a braking torque and wheel slip of the vehicle in a closed loop system using the controller.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a self-excited and controllable Hybrid Electromagnetic Braking (HEB) system, according to an embodiment herein.

FIG. 2 illustrates a flow chart explaining a method of working of a self-excited and controllable HEB system, according to an embodiment herein.

FIG. 3 illustrates a block diagram of a three-phase electrical model of a HEB system, according to an embodiment herein.

FIG. 4 illustrates an equivalent DC model of a HEB system, according to an embodiment herein.

FIG. 5 illustrates a perspective view of a 3-D model of one pole pair of an axial flux ECB in a HEB system, according to an embodiment herein.

FIG. 6 illustrates a graph indicating simulated and modeled Eddy Current Brake (ECB) characteristics in a HEB system, according to an embodiment herein.

FIG. 7 illustrates a cross sectional view of a four poles of a Permanent Magnet Synchronous Generator (PMSG) with concentrated windings, according to an embodiment herein.

FIG. 8a illustrates a top plan view of stator ECB side of a prototyped HEB system, according to an embodiment herein

FIG. 8b illustrates a top plan view of a Regenerative Brake (RB) side of a prototyped HEB system, according to an embodiment herein.

FIG. 9a illustrates a top plan view of a RB rotor of a prototyped HEB system, according to an embodiment herein.

FIG. 9b illustrates a top plan view of a ECB rotor of a prototyped HEB system, according to an embodiment herein.

FIG. 10 illustrates a block circuit diagram of a power electronics interface circuit of a HEB system, according to an embodiment herein.

FIG. 11 illustrates a flow chart explaining a method of operation of a control system and control setup in a HEB system, according to an embodiment herein.

FIG. 12a illustrates a graph indicating the experimental results corresponding to speed control performances with respect to speed tracking function of a HEB system, according to an embodiment herein.

FIG. 12b illustrates a graph indicating the experimental results corresponding to speed control performances with respect to control input function of a HEB system, according to an embodiment herein.

FIG. 12c illustrates a graph indicating the experimental results corresponding to speed control performances with respect to an estimated braking function of a HEB system, according to an embodiment herein.

FIG. 13 illustrates a graph indicating a relationship between a friction coefficient and wheel slip of a controller for different road conditions in a HEB system, according to an embodiment herein.

FIG. 14a illustrate a graph indicating the simulation results for linear speed of wheel and vehicle with respect to time in a HEB system, according to an embodiment herein.

FIG. 14b illustrate a graph indicating the simulation results for wheel slip with respect to time in a HEB system, according to an embodiment herein.

FIG. 15a illustrates a graph indicating the simulation results for slip control performances with respect to a control input, in a HEB system, according to an embodiment herein.

FIG. 15b illustrates a graph indicating the simulation results for slip control performances with respect to braking torque of a HEB system, according to an embodiment herein.

FIG. 15c illustrates a graphs indicating the simulation results for slip control performances with respect braking function of a HEB system, according to an embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, a reference is made to the accompanying drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

According to an embodiment herein, a Hybrid Electromagnetic Braking (HEB) system is provided. The system comprises an Eddy Current Brake (ECB) with an outer rotor assembly placed on a shaft of a vehicle. A Regenerative Brake (RB) with an outer rotor assembly is mounted on the shaft of the vehicle to supply input power to the ECB. A power electronics interface module is arranged between the ECB and the RB to supply the input power received from RB to the ECB. A controller is connected to the power electronics interface module to send a control signal to the power electronics interface module to control a power flow from the RB to the ECB to achieve a desired braking torque.

According to an embodiment herein, the controller receives a current vehicle system conditions and compares the received vehicle system conditions with a stored reference conditions to generate the control signal to control a power flow from the RB to the ECB to achieve the desired braking torque of the vehicle.

According to an embodiment herein, the outer rotor assembly of the RB and the outer rotor assembly of the ECB are mounted on a same shaft.

According to an embodiment herein, the power electronic interface module rectifies AC output power of the RB to a controllable DC power.

According to an embodiment herein, the ECB is configured to produce a first braking torque on the shaft, and wherein the RB is configured to produce a second braking torque on the shaft.

According to an embodiment herein, the outer rotor assembly of the RB and the outer rotor assembly of the ECB are connected to a common internal stator.

According to an embodiment herein, the system further comprises a plurality of sensors for measuring the vehicle conditions.

According to an embodiment herein, the measured vehicle conditions are mass, speed and slip of a vehicle.

According to an embodiment herein, the controller is further configured to track a braking torque and wheel slip of the vehicle in a closed loop system.

According to an embodiment herein, the RB is configured to direct generated power into a storage device of the vehicle.

According to an embodiment herein, a method is provided for initiating a braking action in a vehicle using a self-excited and controllable Hybrid Electromagnetic Braking (HEB) system. The method comprising steps of receiving a break command from a driver of the vehicle; measuring system conditions of the vehicle using a plurality of sensors; calculating a braking torque required to stop the vehicle using a controller; comparing the measured vehicle conditions with a reference vehicle conditions by the controller to generate a control signal for achieving a desired braking torque of the vehicle; forwarding the generated control signal to a power electronic interface module to regulate an input power supply to an Eddy Current Brake (ECB) from a Regenerative Brake (RB) for achieving a desired braking torque of the vehicle; and applying a first braking torque produced by the ECB and a second braking torque produced by the RB on a shaft of the vehicle thereby initiating a braking action to stop the moving vehicle.

According to an embodiment herein, the measured vehicle conditions are mass, speed and slip of a vehicle.

According to an embodiment herein, the method further comprises tracking a braking torque and wheel slip of the vehicle in a closed loop system using the controller.

The various embodiments herein provide a self-excited and controllable Hybrid Electromagnetic Braking (HEB) system. The HEB system comprises an Eddy Current Brake (ECB), a generator or Regenerative Brake (RB), a shaft, a controller, a power electronic interface module, a torque reference module, and sensors. The rotors of the two electromagnetic brakes (ECB and RB) are connected to a common internal stator. The rotor assembly of the ECB is operatively coupled to the shaft of a vehicle motor. The rotor assembly of the RB is also coupled to the same shaft on which the ECB rotor is fixed.

The generator collects input mechanical power from the shaft and supplies the power to the ECB through the power electronic interface module. Thus, the HEB system is self-excited and does not require any external power supply to excite ECB windings. The direct magnetic linkage between the ECB outer rotor and the stator develops a first braking torque (T_{ecb}) on the shaft. The generator also produces an additional braking torque or second braking torque (T_{rb}) on the shaft. The power electronic interface module is a controlled converter whose DC link input is the rectified output of the generator. The power electronic interface module acts as interface between the ECB and the generator and provides a controllable input for ECB windings. The power electronic interface module receives control signal from the controller and regulates supply to the ECB based on the received control signal. The controller measures system states of the vehicle and further calculates required braking torque to stop the vehicle. According to one embodiment of the embodiments herein, the system states measured by the controller are mass, speed and slip of the vehicle.

The HEB system receives a brake command from a driver of the vehicle. The controller measures system states of the vehicle and calculates braking torque required to stop the vehicle. According to one embodiment of the embodiments herein, the system states are measured using suitable sensors in the HEB system. The measured system states are mass, speed and slip of the vehicle. Further, the controller checks whether the measured system states matches with the desired system states of the vehicle. When the measured system states does not match with the desired system states, the controller triggers a power electronic interface module to supply input power to the ECB for improving the braking performance. Based on the command signal received from the controller, the power electronic interface module regulates power to the ECB windings. The resultant torque developed from the ECB rotor and a RB rotor is applied on the vehicle shaft. After applying the torque on the vehicle shaft, the controller again measures the system states and checks whether the measured system states matches with desired system states. When the measured system states matches with the desired braking performance, a braking action in the vehicle is initiated and stops the moving vehicle.

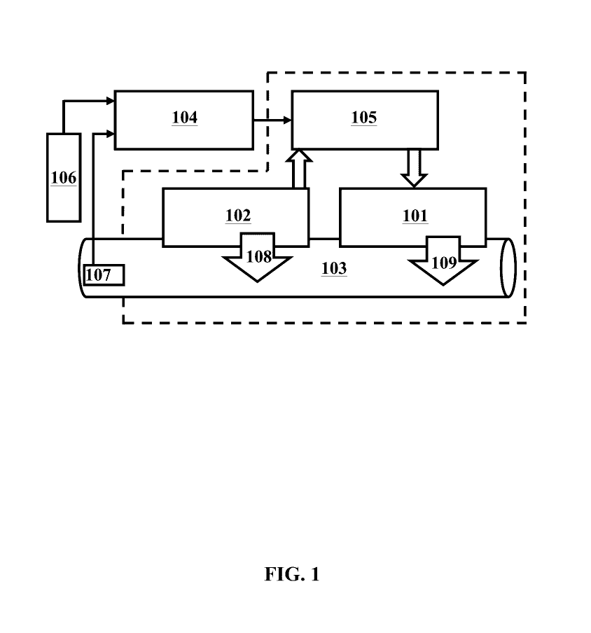

FIG. 1 illustrates a functional block diagram of a self-excited and controllable Hybrid Electromagnetic Braking (HEB) system, according to an embodiment herein. With respect to FIG. 1, the HEB system comprises Eddy Current Brake (ECB) 101, generator or Regenerative Brake (RB) 102, shaft 103, controller 104, power electronic interface module 105, torque reference module 106, and sensors 107. The outer rotor assembly of two electromagnetic brakes (ECB 101 and RB 102) are connected to a common internal stator. Further, the outer rotor assembly of the ECB 101 is operatively coupled to the shaft 103. The outer rotor assembly of the RB 102 is also coupled to the same shaft 103 on which the ECB 101 rotor is mounted.

The generator 102 collects an input mechanical power from the shaft 103 and supplies the power to the ECB 101 through the power electronic interface module 105. Thus, the HEB system is self-excited and does not require any external power supply to excite the ECB 101 windings. The direct magnetic linkage between the ECB 101 outer rotor and the stator develops a first braking torque (T_{ecb}) 109 on the shaft 103. The generator 102 also produces an additional braking torque or second braking torque (T_{rb}) 108 on the shaft 103. The power electronic interface module 105 is a controlled converter whose DC link input is the rectified output of the generator 102. The power electronic interface module 105 acts as interface between the ECB 101 and the generator 102 to provide a controllable input for ECB 101 windings. The power electronic interface module 105 receives a control signal from the controller 104 to regulate a power supply to the ECB 101 based on the received control signal. The controller 104 measures system states of the vehicle to calculate the required braking torque to stop the vehicle. According to one embodiment herein, the system states measured by the controller are mass, speed and slip of the vehicle. The controller 104 measures the system states of the vehicle by using the sensors 107.

According to one embodiment herein, the brake structures of ECB 101 and RB 102 is designed in either axial-flux type or radial-flux type. The size, material, and electromagnetic properties of the ECB 101 and the RB 102 are varied depending on the application requirements. The windings of the ECB 101 and the RB are of same type or different types.

According to one embodiment herein, the HEB system has a superior braking performance when compared with a Permanent Magnet Synchronous Generator (PMSG) supplying a resistive load. Because, the secondary braking torque component (T_{rb}) produced in the HEB system more effectively contributes to the braking action of the vehicle.

According to one embodiment herein, the controller 104 tracks a braking performance of the vehicle while ensuring a stability of closed loop system.

According to one embodiment herein, for vehicular applications, the required braking torque for a given vehicle mass and deceleration is calculated using Newton's 2nd law. The in-wheel HEB system for a given available space produces the whole or a part of the required braking torque based on the vehicle parameters such as mass, speed, and slip.

According to one embodiment herein, the HEB system directs the generated power of the RB into storage devices such as batteries when the rate of energy to be stored is high in the vehicle.

According to one embodiment herein, for vehicular applications, the available volume related to wheel size (radius) is a major constraint. Because the wheel radius is determined in advance in the aero-dynamical design stage of a vehicle. The brake mass is affected by physical and electromagnetic properties of the used material. The dimensions of tooth and yoke are determined based on the mass density and knee-point flux density values. The mass density and knee-point flux density values varies based on the type of magnetic material used for constructing the core.

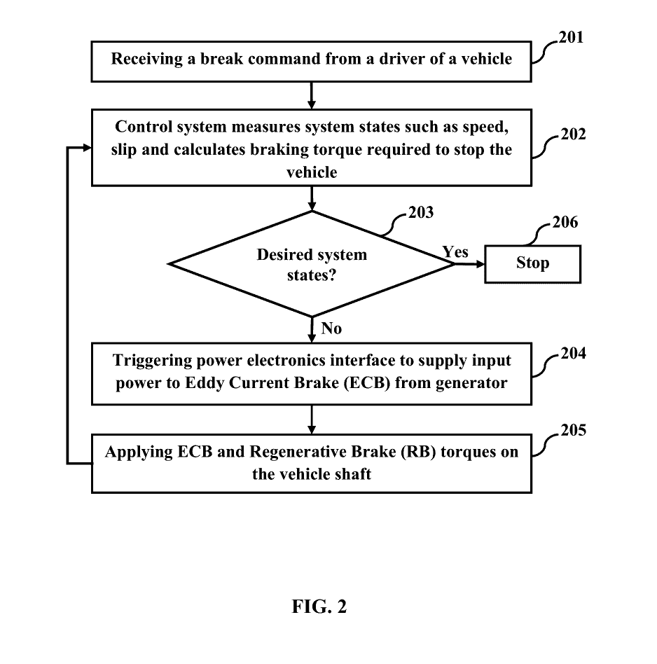

FIG. 2 illustrates a flow chart explaining a method of working of a self-excited and controllable HEB system, according to an embodiment herein. With respect to FIG. 2, the HEB system receives a brake command from a driver of the vehicle (201). The controller measures the system states or conditions of the vehicle and calculates braking torque required to stop the vehicle (202). According to one embodiment herein, the system states/conditions are measured using suitable sensors in the HEB system. The measured system states/conditions are mass, speed and slip of the vehicle. Further, the controller checks whether the measured system states/conditions matches with the desired system states/conditions of the vehicle (203). When the measured system states/conditions does not match with the desired system states/conditions, the controller triggers a power electronic interface module to supply the input power to the ECB for improving the braking performance (204). Based on the command signal received from the controller, the power electronic interface module regulates the power to the ECB windings. The resultant torque developed from the ECB rotor and a RB rotor is applied on the vehicle shaft (205). After applying the torque on the vehicle shaft, the controller again measures the system states and checks whether the measured system states matches with desired system states. When the measured system states matches with the desired braking performance, a braking action in the vehicle is initiated and stops the moving vehicle (206).

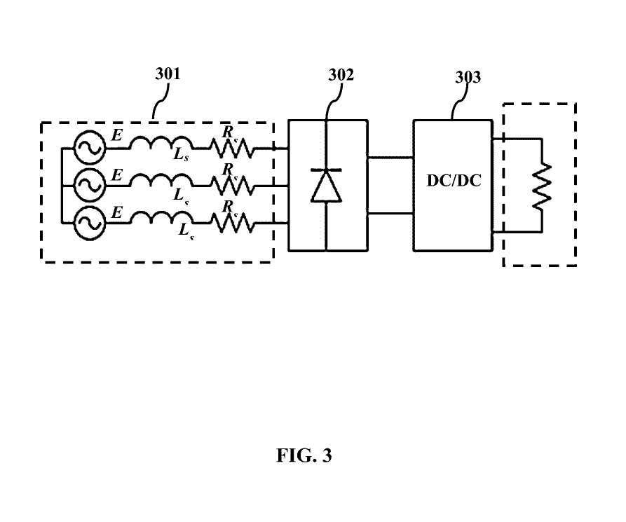

FIG. 3 illustrates a block diagram of a three-phase electrical model of a HEB system, according to an embodiment herein. With respect to FIG. 3, the HEB system consists of three basic parts and each part is represented by an electrical circuit 301, 302, and 303. The power electronic interface module rectifies the AC output of the generator 301 to a controllable DC level. According to one embodiment of the embodiments herein, various rectifying solutions are analyzed based on the three-phase diode rectifiers 302 that are suitable for variable speed applications. The controlled three-phase rectifier requires a lower number of switches and is represented by a series connected diode rectifier and a DC/DC converter 303.

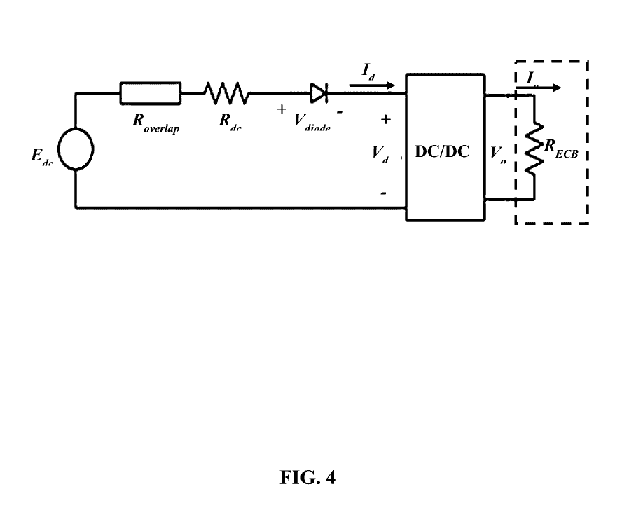

FIG. 4 illustrates an equivalent DC model of a HEB system, according to an embodiment herein. With respect to FIG. 4, due to commutating inductance, the three-phase generator connected to a diode rectifier in FIG. 3 is modeled by its open circuit DC voltage (E_{dc}), its equivalent resistance (R_{dc}), and the equivalent overlap resistance (Rₒᵥₑᵣₗₐₚ) in FIG. 4.

According to one embodiment herein, the DC/DC converter is a step-down or step-up converter based on the required output level. As a general solution, a Cuk converter is designed and implemented in FIG. 4. The main advantage of the Cuk convertor is the continuous flow of currents at both the input and the output of the converter. The ECB is modeled by its steady-state equivalent DC resistance (Rₒ) and dissipated power (P_{ECB}).

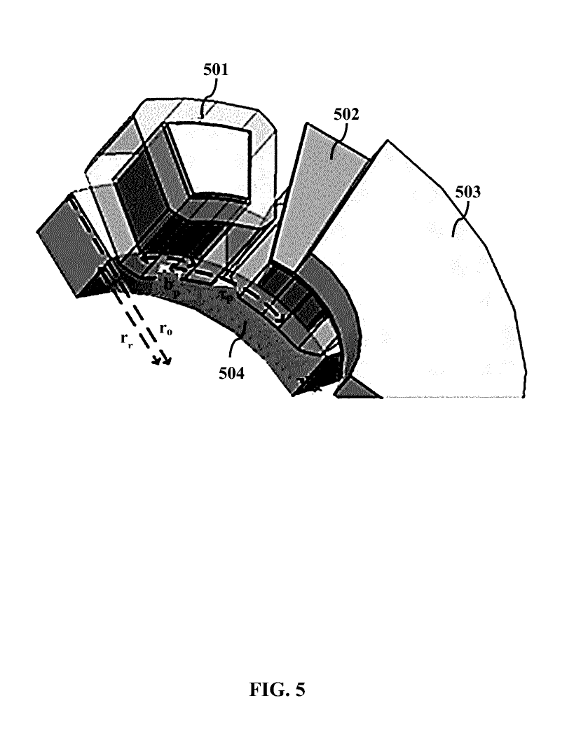

FIG. 5 illustrates a perspective view of a 3-D model of one pole pair of an axial flux ECB in a HEB system, according to an embodiment herein. With respect to FIG. 5, the structure of an axial-flux ECB comprises coil 501, conductive layer 502, primary's back iron section 503, and secondary's back iron section 504. The magnetic flux density in the air-gap of the ECB is achieved by performing preliminary designs based on a Magnetic Equivalent Circuit (MEC). The assumptions for electrical and magnetic parameters, geometrical design constraints, and the calculated parameters of the preliminary designed ECB are summarized in Table 1.

TABLE 1

| Parameter | Value | Parameter | Value |
|---|---|---|---|
| rₒ, r_{i (}mm) | 62.5, 42.5 | B_{g} (T) | 0.8 |
| kᵣ | 0.68 | K_{fll} | 0.5 |
| g, l_{c} (mm) | 1, 1 | J (A/mm²) | 9.6 |
| hₛ (mm) | 30 | A (mm²) | 0.1963 |
| D (mm) | 9.03 | N_{c} | 690 |
| τₚ, bₚ (mm) | 41.23, 18.93 | R_{c} | 7.52 |
| kₚ | 0.46 | P_{ECB} | 21.3 |
| p | 4 | Conductive layer | Copper |

According to one embodiment herein, for a fixed outer radius and operating speed of 0-1500 rpm, the design of Table 1 is selected as the ECB part of the HEB system. Further, parametric analysis with maximum torque density, critical speed, and practical situations are considered while prototyping the ECB system.

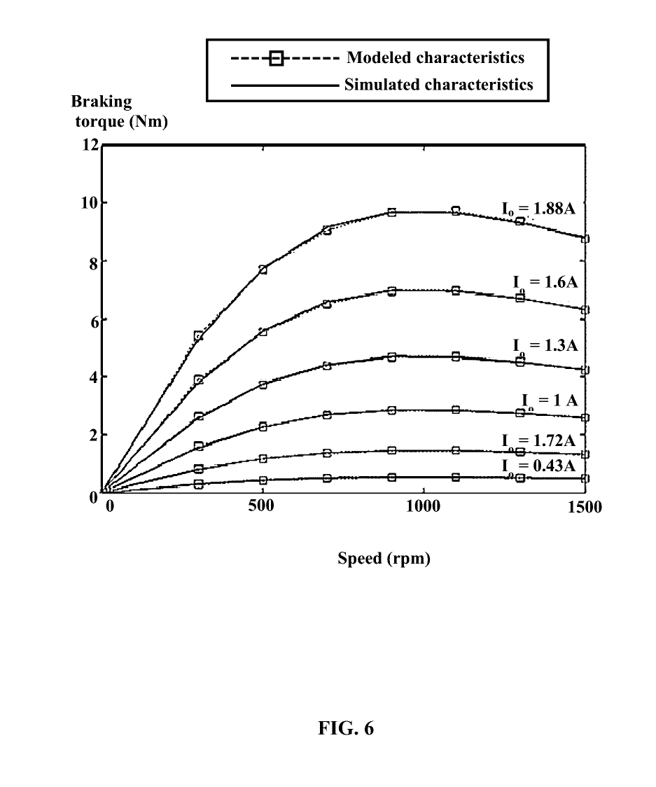

FIG. 6 illustrates a graph indicating simulated and modeled Eddy Current Brake (ECB) characteristics in a HEB system, according to an embodiment herein. According to one embodiment herein, the ECB torque component of an ECB depends on the ECB current and speed, and is modeled with the following function:

T_{ecb}(ω,Iₒ)=ƒ₀(ω)+ƒ₁(ω)×Iₒ+ƒ₂(ω)×Iₒ² (1)

The friction and windage torques are considered by the ƒₒ(ω) term. The functions of ƒi are polynomials that characterize the dependency of the braking torque to the speed.

ƒᵢ(φ)=a₀ᵢ+a₁ᵢω+a₂ᵢω²+ . . . +aₘᵢω^{m} (2)

The model parameters aᵢⱼ are found by a two stage method based on least-square curve fitting. The simulated and modeled characteristics, as well as the model parameters of the understudy ECB assuming 3rd-order polynomials are represented the following Table 2:

TABLE 2

| Parameter | Value | Parameter | Value |
|---|---|---|---|
| a₀₀ | 2.8367e−4 | a₂₁ | −58135e−10 |
| a₁₀ | −1.5165e−4 | a₃₁ | 1.4849e−13 |
| a₂₀ | 1.4569e−7 | a₀₂ | −2.2026e−8 |
| a₃₀ | −4.2395e−11 | a₁₂ | 1.3126e−8 |
| a₀₁ | −3.0114e−6 | a₂₂ | −9.4529e−12 |
| a₁₁ | 6.6641e−7 | a₃₂ | 1.9744e−15 |

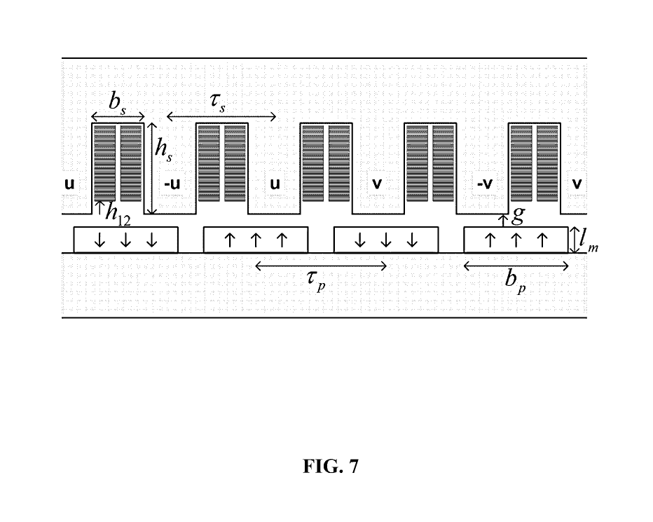

FIG. 7 illustrates a cross sectional view of a four poles of a Permanent Magnet Synchronous Generator (PMSG) with concentrated windings, according to an embodiment herein. With respect to FIG. 7, an axial-flux generator supplies axial-flux ECB in the HEB system. When compared with other types of generators, the Permanent Magnet Synchronous Generator (PMSG) is more useful and preferred, because of its efficiency, energy yield and no requirement of additional power supply for the field excitation, especially at low speed applications. For variable-speed direct-driven applications such as wind turbines, automotive applications, or human power generation, the PMSG is followed by a converter circuit.

According to one embodiment herein, the preliminary design specifications of the axial-flux PMSG are: 9/8 double-layer concentrated winding, RB delivers kₚ₁% of P_{ECB, max} at minimum speed (nₘᵢₙ) and kₚ₂% above 2nₘᵢₙ. Further, the specifications are subjected to the inner and outer radii regarding the ECB, minimum possible slot depth and the axial length, magnetic flux density in the narrowest part of the stator tooth less than Bₘₐₓ and the peak line current density in the average radius less than A_{m, max}.

According to one embodiment herein, the RB design variables to meet the minimum requirements are: PM width (bₚ), PM thickness (lₘ), hₛ and h₁₂, the slot-width to pitch ratio (bₛ/τₛ), and the coil number of turns (N_{c}). The higher kₚ₁ and kₚ₂ values results in more material usage, increased axial length and mass, and higher electric and magnetic loadings.

According to one embodiment herein, an optimization algorithm is used to find the design that indicates the highest torque capability in the low-speed range. The parameters of the optimized design are provided in below Table 3:

TABLE 3

| Parameter | Value | Parameter | Value |
|---|---|---|---|
| h_{s (}mm) | 30 | Lₛ (H) | 0.18857 |
| h₁₂ (mm) | 0 | N_{c} | 499 |
| bₛ/τₛ | 0.40 | a_{cu} (mm²) | 0.1963 |
| bₚ (mm) | 20 | Nₘᵢₙ (rpm) | 300 |
| lₘ (mm) | 5 | Lg (mm) | 1 |
| Rₛ | 16.4778 | PM type | NdFeB35 |

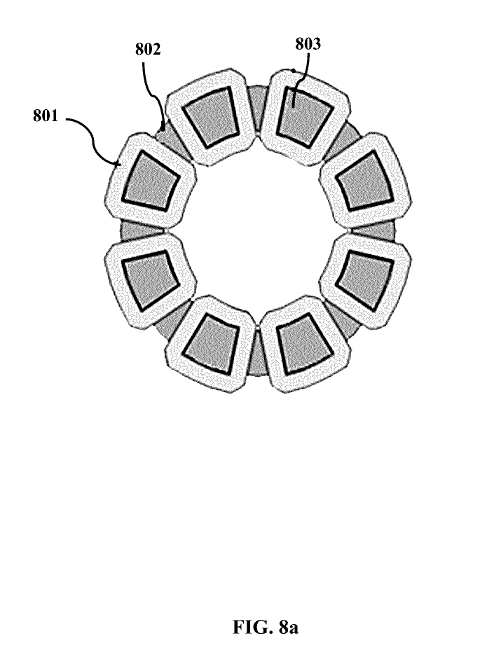

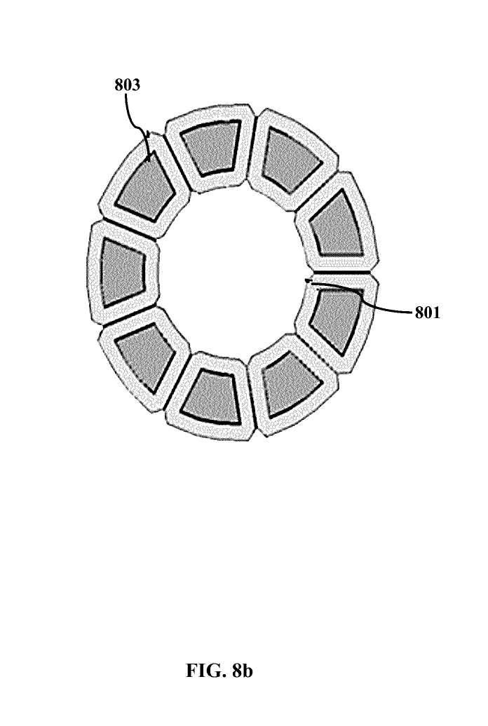

FIGS. 8a and 8b illustrates stator ECB side and RB side of a prototyped HEB system respectively, according to an embodiment herein. With respect to FIGS. 8a and 8b, the stator ECB side and RB side comprises coil 801, stator core 802, and pole 803. According to one embodiment of the embodiments herein, the core material of the stator is the laminated steel CRGO-M5. The coils of the ECB 801 and the RB 801 are placed on two sides of the double-sided stator core 802. The ECB and RB have isolated magnetic flux paths in the stator core 802. Thus, there is no magnetic coupling between the two parts of the HEB.

According to one embodiment herein, the room temperature during the experiments is fixed at 30° C. Due to short operating intervals of the HEB and adequate windage-cooling, thermal effects on the parameters, such as coil resistance are negligible. Further, the heat produced by the EC losses in the conductive layer of the ECB changes the torque-speed characteristics. The effect of heat on torque-speed characteristics are considered while designing a torque-based controller.

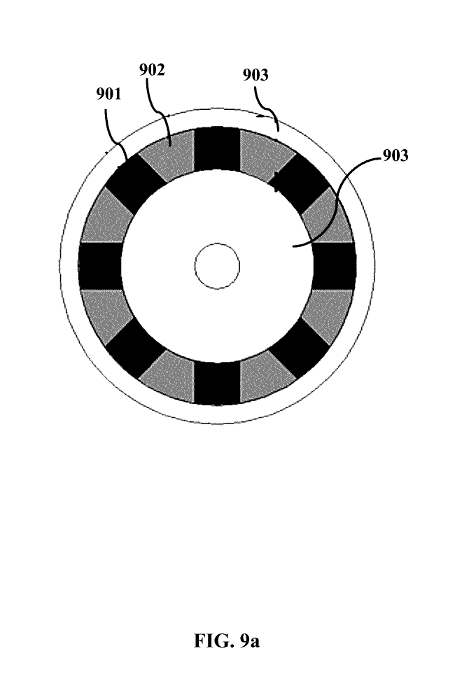

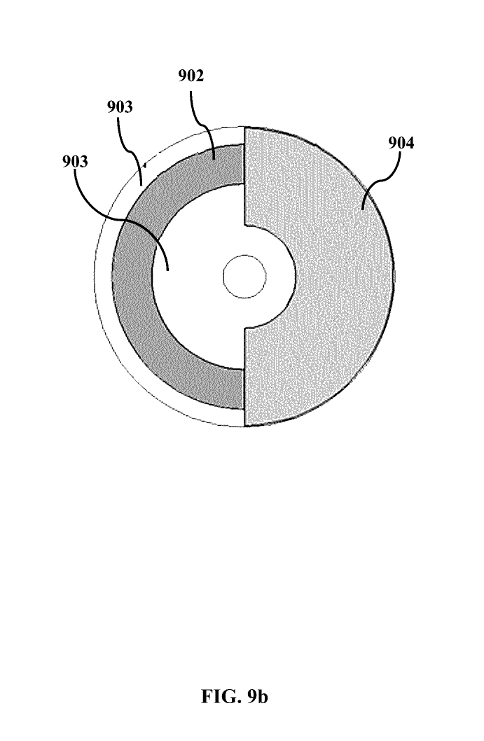

FIGS. 9a and 9b illustrates RB rotor and ECB rotor of a prototyped HEB system respectively, according to an embodiment herein. With respect to FIGS. 9a and 9b, the RB rotor and ECB rotor comprises Permanent Magnet 901, pole 902, aluminum layers 903 and copper covering 904. According to one embodiment of the embodiments herein, the core material of the rotors is the laminated steel CRGO-M5.

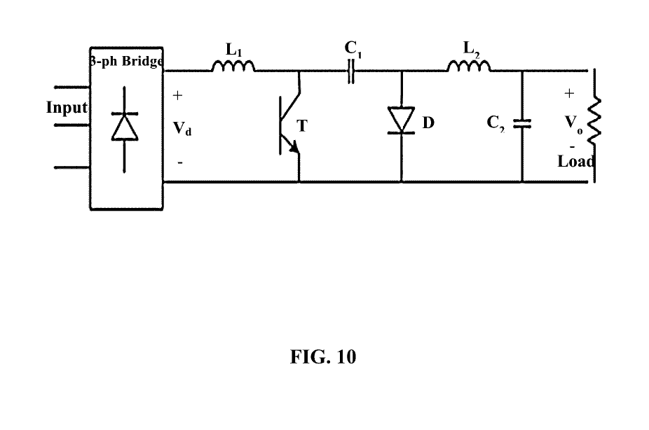

FIG. 10 illustrates a block circuit diagram power electronic interface circuit of a HEB system, according to an embodiment herein. The power electronic circuit acts as interface between the ECB and the RB and provides a controllable input for ECB windings. Further, the circuit is configured to rectify the AC output of the generator to a controllable DC input power. The power electronic interface circuit receives control signals from the controller and regulates supply to the ECB based on the received control signals.

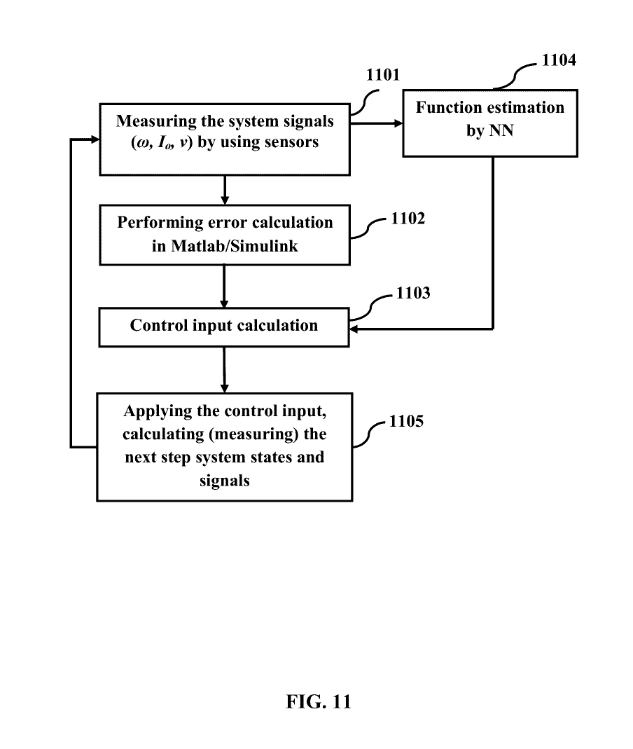

FIG. 11 illustrates a flow chart explaining a method of implementing control system and control setup of a HEB system, according to an embodiment herein. According to one embodiment herein, the total braking torque of the HEB has two components: an ECB torque (τ_{ecb}), and a RB (τ_{rb}) torque. The first component (τ_{ecb}) depends on the ECB current and speed. The braking torque of the second component is calculated using total output power of the generator. The total output power of the generator consists of the delivered power to the ECB, and the total losses, including the core, the PM, the winding, and the converter losses and is given by:

$${T}_{b} ( ω , {I}_{o} ) = {f}_{o} ( ω ) + ( 1 + {k}_{Fe + PM} ) \frac{{P}_{0 , conv}}{ω} + {I}_{o} [ {f}_{1} ( ω ) + ( 1 + {k}_{Fe + PM} ) \frac{{k}_{1 , conv}}{ω} ] + {I}_{o}^{2} [ {f}_{2} ( ω ) + ( 1 + {k}_{Fe + PM} ) \frac{( {R}_{o} + {k}_{2 , conv} )}{ω} ] + \frac{3 {R}_{s} {I}_{r m s}^{2}}{ω} \qquad ( 3 )$$

where, k_{i,conv}, k_{Fe+PM}, Rₛ and Rₒ are the converter loss coefficients, core and PM loss coefficient, the stator resistance, and the ECB equivalent DC resistance.

According to one embodiment herein, the hybrid electromagnetic brake model proposed in equation (3) is an accurate model that considers the nonlinear effects when the effects of parameters such as k_{1,conv}, k_{2,conv}, Rs, Rₒ, k_{Fe+PM} and a₀₀ to a₃₂ are evaluated online by a suitable technique. The nonlinear effects are caused due to nonlinear characteristics of the brake parts such as converter, and also due to the environmental issues such as temperature.

According to one embodiment herein, the resulted model contains parametric uncertainties that affect the closed-loop performance of the controller. The uncertainties are mainly due to the temperature variations in the system. The uncertainties include: increase in RB and ECB winding resistances (Rs, Rₒ) with rise in system temperature, variations of ECB characteristic model parameters (a₀₀, . . . , a₃₂) due to the rotor temperature, and variation in conductivity of ECB due to variation of characteristic model parameters (a₀₀, . . . , a₃₂). Further, the uncertainties in coefficients corresponding to core, PM, and converter losses (k_{Fe+PM}, P_{0,conv}, k_{1,conv}, k_{2,conv}) and uncertainties corresponding to prime mover torque, the wheel moment of inertia, and vehicle mass also affect the closed-loop performance of the controller. The uncertainties in the ECB characteristic model parameter variations are due to considerable heat produced by the eddy current losses in the rotor of the brake system.

According to one embodiment herein, Lyapunov theorem for global stability is used to design the controllers. Based on the design of the controllers, the stability of the closed-loop system is determined and a reference output is tracked. Due to parametric uncertainties in the resultant model, functions in the control law are undetermined.

According to one embodiment herein, NNs are used for controlling highly nonlinear, uncertain, and complex systems. The NN architectures are applied for modeling unknown functions in dynamic systems. All errors and weights are bounded and the tracking error is reduced to an arbitrary small value by certain design parameters. Further, the NN is trained on-line in the closed loop and allows to use the same controller for two different nonlinear systems.

According to one embodiment herein, robust speed and slip controllers are designed to verify the performance of the hybrid electromagnetic braking system. Initially, the system signals ω, Iₒ, ν are measured by using the sensors and the signals are imported to Matlab/Simulink through a DSP board (1101). Further, the error calculation is performed online in the Matlab/Simulink (1102). After performing the error calculation, function estimation, and control input calculations are performed online in the Matlab/Simulink (1103) (1104). Further, the control input signal is exported to the controlled converter through the DSP board and the next step system signals ω, Iₒ, ν are measured and imported again Matlab/Simulink through the DSP board (1105).

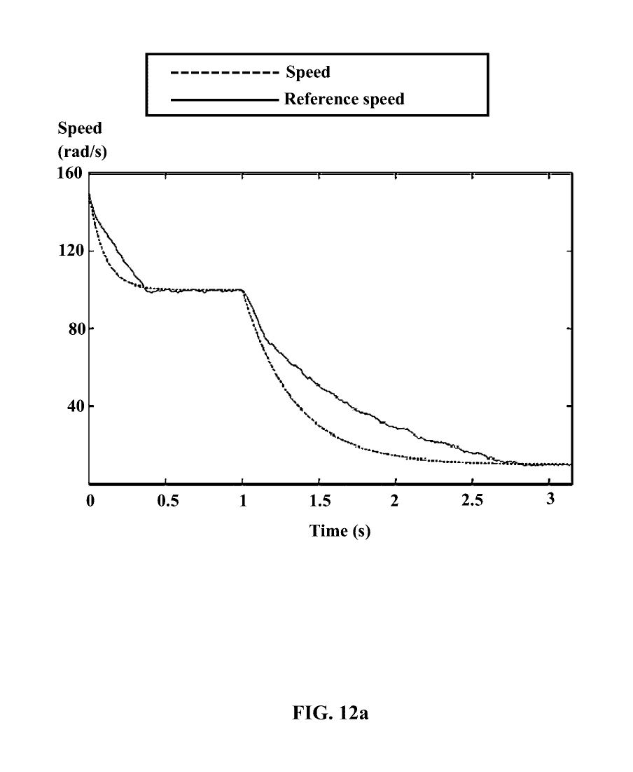

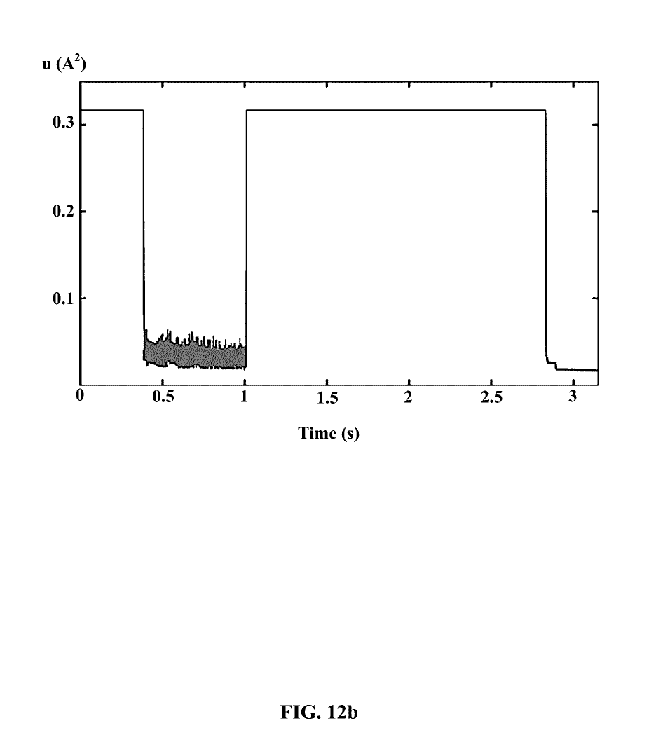

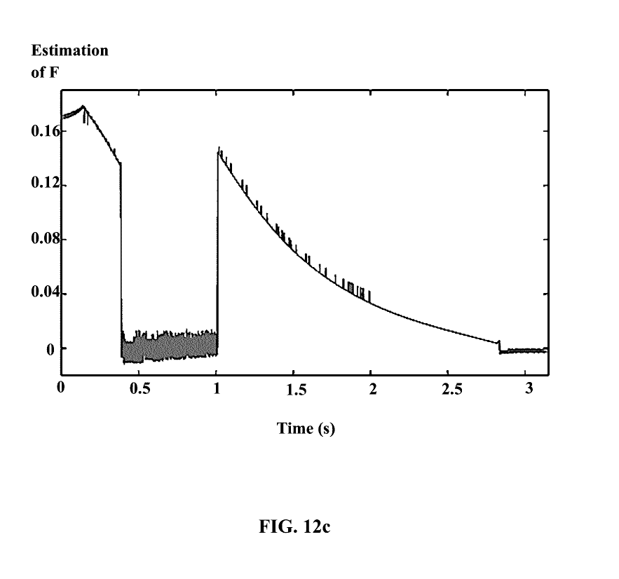

FIGS. 12a-12c illustrate graphs representing experimental results corresponding to speed control performances such as the speed tracking, control input, and estimated function of a HEB system, according to an embodiment herein. With respect to FIG. 12a, the sold line represents the speed of the vehicle and the dotted line represents the reference speed.

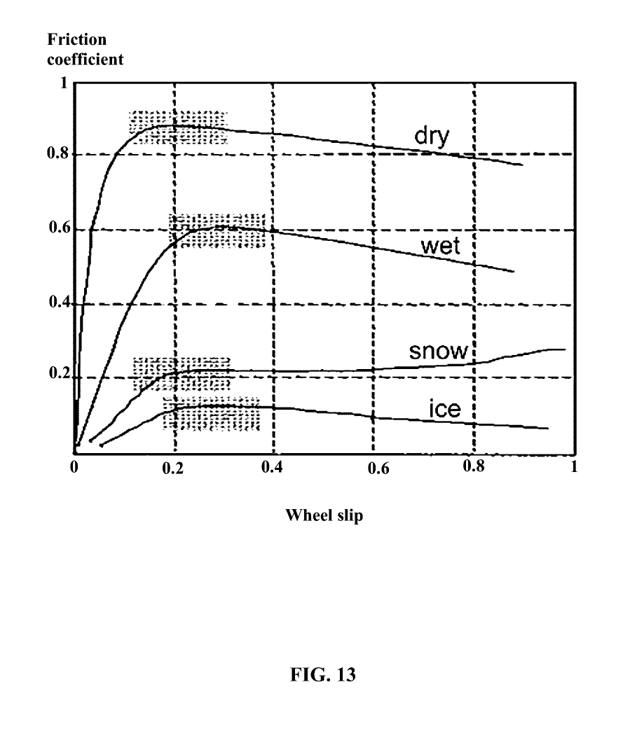

FIG. 13 illustrates a graph representing friction coefficient versus wheel slip of a controller for different road conditions, according to an embodiment herein. According to one embodiment of the embodiments herein, an Antilock Braking System (ABS) is developed based on a simplified vehicle model and a robust control algorithm using NNs. The controller keeps the wheel slip at a value corresponding to the maximum tire-ground adhesion. With respect to FIG. 13, the friction coefficient (deceleration of the vehicle) has a peak for the wheel slip between 0.15 and 0.3 depending on the road condition. Also, for slips close to unity the wheel is more prone to being locked which rises an unwanted condition.

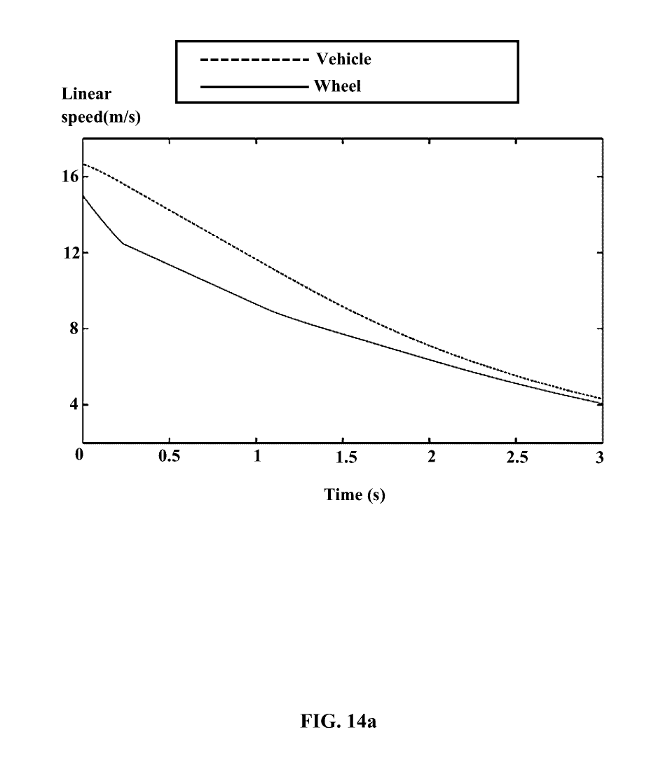

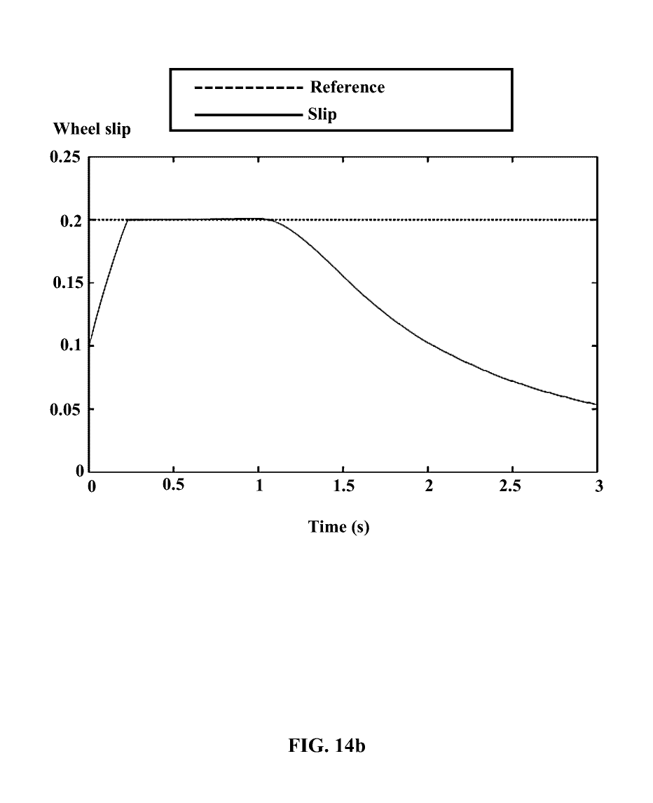

FIGS. 14a and 14b illustrate graphs representing simulation results for wheel linear speed and wheel slip in a HEB system, according to an embodiment herein. With respect to FIG. 14a, the dotted line represents vehicle speed and the solid line represents wheel speed. With respect to FIG. 14b, the dotted line represents reference slip and the solid line represents wheel slip. The wheel slip reaches the reference value in about 0.2 s and holds the value for about 1 s. After 1 s, the wheel slip starts to decrease with time.

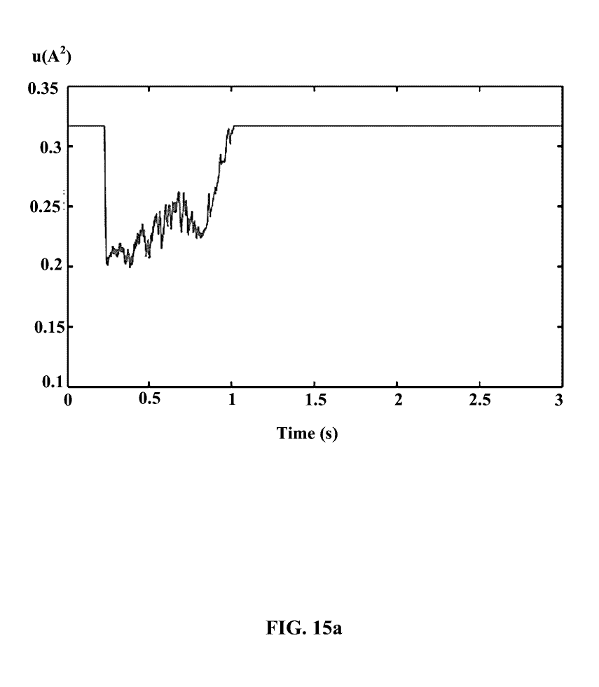

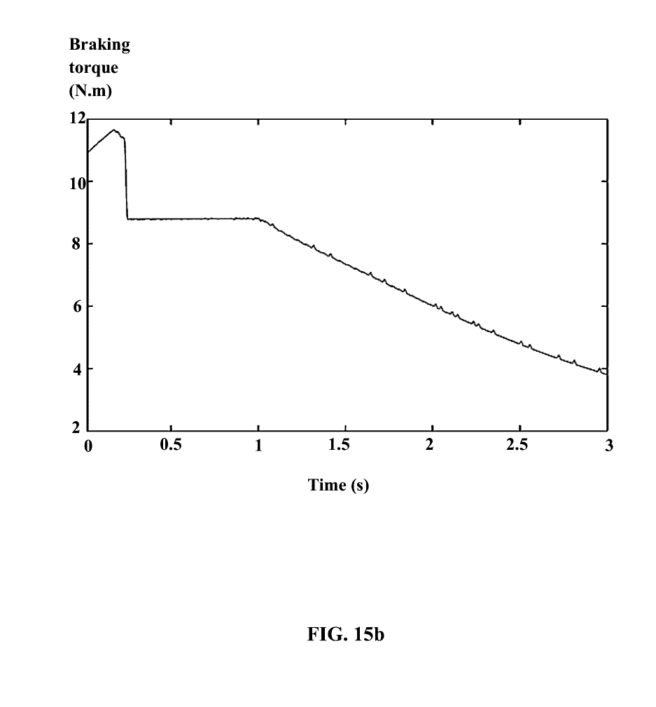

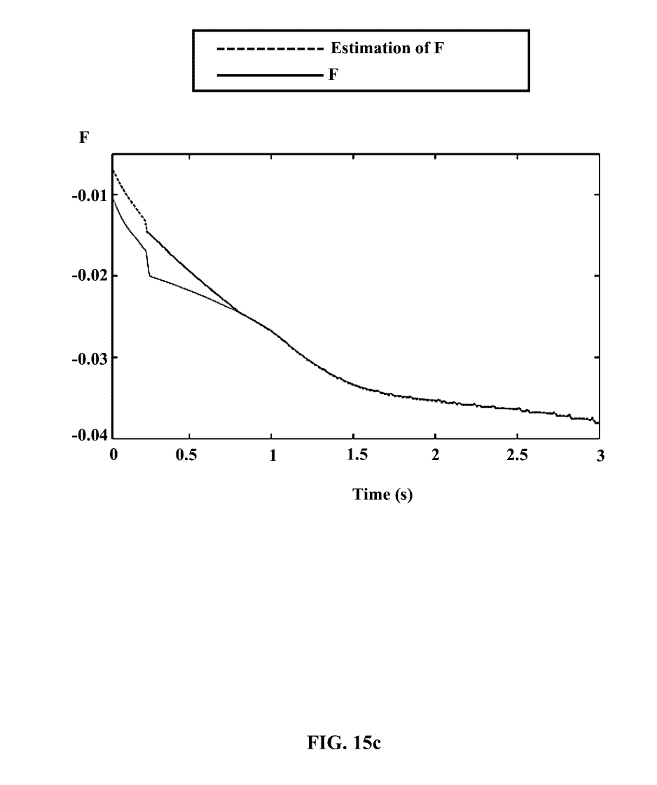

FIGS. 15a-15c illustrate graphs representing simulation results for slip control performances such as control input, braking torque, and function estimation of a HEB system respectively, according to an embodiment herein. With respect to FIG. 15a and FIG. 15b, the controller tries to apply more braking torque to increase the wheel slip, but as the braking torque of the ECB is proportional to the speed, at low speeds, the total braking torque of the hybrid electromagnetic braking system is not enough for the requested deceleration of the wheel. FIG. 15c illustrates the function estimation performance of the NN showing the convergence in 0.7 s time frame.

The material used for manufacturing of stator of both RB and ECB is CRGO-M5. According to one embodiment herein, the stator is designed and constructed in any desired size using different materials based on application requirements.

The material used for manufacturing of rotor is CRGO-M5. The material used for manufacturing of rotor CL is copper. The material used for manufacturing of rotor PMs is NdFeB35. According to one embodiment of the embodiments herein, the rotor and rotor cores are designed and constructed in any desired size using different materials based on application requirements.

According to one embodiment herein, the material used for manufacturing of stator core holder and rotor core holder is Aluminum. According to one embodiment herein, the stator and rotor core holders are designed and constructed in any desired size using different materials based on application requirements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A Hybrid Electromagnetic Braking (HEB) system comprising:
an Eddy Current Brake (ECB) with an outer rotor assembly placed on a shaft of a vehicle;
a Regenerative Brake (RB) with an outer rotor assembly mounted on the shaft of the vehicle to supply input power to the ECB;
a power electronics interface module arranged between the ECB and the RB to supply the input power received from RB to the ECB; and
a controller connected to the power electronics interface module to send a control signal to the power electronics interface module to control a power flow from the RB to the ECB to achieve a desired braking torque.

2. The system according to claim 1, wherein the controller receives a current vehicle system conditions and compares the received vehicle system conditions with a stored reference conditions to generate the control signal to control a power flow from the RB to the ECB to achieve the desired braking torque of the vehicle.

3. The system according to claim 1, wherein the outer rotor assembly of the RB and the outer rotor assembly of the ECB are mounted on a same shaft.

4. The system according to claim 1, wherein the power electronic interface module rectifies AC output power of the RB to a controllable DC power.

5. The system according to claim 1, wherein the ECB is configured to produce a first braking torque on the shaft, and wherein the RB is configured to produce a second braking torque on the shaft.

6. The system according to claim 1, wherein the outer rotor assembly of the RB and the outer rotor assembly of the ECB are connected to a common internal stator.

7. The system according to claim 1, further comprises a plurality of sensors for measuring the vehicle conditions.

8. The system according to claim 1, wherein the measured vehicle conditions are mass, speed and slip of a vehicle.

9. The system according to claim 1, wherein the controller is further configured to track a braking torque and wheel slip of the vehicle in a closed loop system.

10. The system according to claim 1, wherein the RB is configured to direct generated power into a storage device of the vehicle.

11. A method for initiating a braking action in a vehicle using a self-excited and controllable Hybrid Electromagnetic Braking (HEB) system, the method comprising steps of:
receiving a break command from a driver of the vehicle;
measuring system conditions of the vehicle using a plurality of sensors;
calculating a braking torque required to stop the vehicle using a controller;
comparing the measured vehicle conditions with a reference vehicle conditions by the controller to generate a control signal for achieving a desired braking torque of the vehicle;
forwarding the generated control signal to a power electronic interface module to regulate an input power supply to an Eddy Current Brake (ECB) from a Regenerative Brake (RB) for achieving a desired braking torque of the vehicle; and
applying a first braking torque produced by the ECB and a second braking torque produced by the RB on a shaft of the vehicle thereby initiating a braking action to stop the moving vehicle.

12. The method according to claim 11, wherein the measured vehicle conditions are mass, speed and slip of a vehicle.

13. The method according to claim 11, further comprises tracking a braking torque and wheel slip of the vehicle in a closed loop system using the controller.
